(19) United States
(12) Patent Application Publication
(10) Pub. No.: US 2006/0132917 A1
(43) Pub. Date: Jun. 22, 2006

(54) Method for making an optical system with coated optical components and optical system made by the method

(75) Inventors: Christoph Zaczek, Heubach (DE); Thomas Muelders, Aalen (DE); Toralf Gruner, Aalen-Hofen (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 11/274,152

(22) Filed: Nov. 16, 2005

Related U.S. Application Data
(60) Provisional application No. 60/627,906, filed on Nov. 16, 2004.

(51) Int. Cl. G02B 27/28

(52) U.S. Cl. 359/495; 359/483

(57) ABSTRACT

In a method for making an optical system for imaging a radiation distribution from an input surface of the optical system into an output surface of the optical system, the optical system has a multiplicity of optical components which determine an imaging quality of the optical system, which are arranged along an optical axis of the optical system and comprise at least one optical component which has a substrate with a substrate surface which is provided for carrying an interference layer system having a layer construction that determines the optical properties of the optical component covered with the interference layer system. The method includes: predefining an optimization target for at least one imaging quality parameter that represents the imaging quality of the system; determining the imaging quality of the optical system while taking account of the layer construction of the interference layer system; and varying the layer construction for approximating the imaging quality parameter to the optimization target. In accordance with the method, the determination of the optimum layer construction is coupled directly with an assessment and of the imaging quality of the total system including the interference layer system to be optimized.

This application claims the benefit of U.S. Provisional Application No. 60/627,906, filed Nov. 16, 2004.

### BACKGROUND OF THE INVENTION

1. Field of the Invention

The invention relates to a method for making an optical system for imaging a radiation distribution from an input surface of the optical system into an output surface of the optical system, and to an optical system which can be made or is made with the aid of the method. A preferred field of application for the invention is making optical imaging systems for microlithographic projection exposure apparatuses. The input surface and the output surface may be optically conjugate field planes, for example the object plane and the image plane of a projection objective.

2. Description of the Related Prior Art

Projection exposure apparatuses for microlithography are used for fabricating semiconductor components and other finely patterned devices. They serve for projecting patterns from photomasks or reticles, referred to hereinafter generally as masks or reticles, onto an object coated with a radiation-sensitive layer, for example onto a semiconductor wafer coated with photoresist, with very high resolution on a demagnifying scale.

In the process for photolithographically patterning semiconductor components, it is of crucial importance that all structure directions, in particular horizontal and vertical structures, be imaged with essentially the same imaging quality. The imaging quality of lithography objectives is determined not only by the correction state of the aberrations, but also by the profile of the intensity over the field and over the pupil of each field point. The profiles in field and pupil are intended to be as uniform as possible. Local intensity modulations in the image plane are to be avoided inter alia because the binary resist materials that are customary nowadays have a great nonlinear characteristic curve of sensitivity which, to a first approximation, can be modeled by the fact that an exposure takes place above an intensity threshold, while no exposure takes place below the intensity threshold. As a result, the spatial intensity profile directly influences the width of the structures produced on the semiconductor component. The more uniform the linewidth over the field and over different structure directions, the higher may be the clock frequency when using the finished semiconductor component and correspondingly the performance and the price of the finished semiconductor component. Therefore, the variation of the critical dimensions (CD variation) is an important quality criterion. The CD variation should be as low as possible.

The variation of the critical dimensions may have different, alternatively or cumulatively effective causes. Especially in systems that operate with polarized light, reflectivity or transmission properties of interference layer systems that are dependent on the angle of incidence may lead to nonuniformities of the intensity over field and pupil. This problem area may occur in the case of purely refractive (dioptric) imaging systems, in particular in high-aperture systems having many lenses coated with antireflection layers. The abovementioned causes may occur to a particularly pronounced extent in catadioptric projection objectives, that is to say in those systems in which refractive and reflective components, in particular lenses and imaging mirrors, are combined.

When utilizing imaging mirror surfaces, it is advantageous to use beam splitters if an imaging that is free of obscuration and free of vignetting is to be achieved. Systems with geometrical beam splitting and also systems with physical beam splitting, for example with polarization beam splitting, are possible. The use of mirror surfaces in such projection objectives may contribute to CD variations arising during imaging.

When using synthetic quartz glass and fluoride crystals, such as calcium fluoride, it must furthermore be taken into consideration that these materials are stress-optically effective. They may bring about polarization-altering effects on account of induced and/or intrinsic birefrigence on the light passing through, which effects likewise contribute to CD variations arising. Finally, material defects, e.g. scattering centers or striations in transparent components, may also lead to nonuniformities of the intensity distribution.

It is possible to influence the imaging quality of optical systems by way of the layer construction of interference layer systems. The drafting of a layer design may for example be targeted at minimizing at least the influences of the layers on the total transmission. It has also already been attempted to use interference layer systems to compensate for apodization effects originating from other polarization-optically effective components. The applicant's international patent application bearing the file reference PCT/EP02/11022 describes a catadioptric projection objective, the catadioptric objective part of which has a concave mirror and a beam deflection device with a physical beam splitter, which comprises a polarization-selective beam splitter layer which is tilted relative to the optical axis. In one embodiment, the layer construction of the beam splitter layer is chosen such that the profiles of the reflectance R_{S} for s-polarized light and of the transmittance T_{P} for p-polarized light which are dependent on angle of incidence are oppositely directed in such a way that a transmission product R_{S}·T_{P} for corresponding angles θ of incidence is essentially constant over the entire angle of incidence range.

In the conventional optimization of layer systems whose layer construction is characterized by the number, sequence and the (optical) layer thicknesses of the individual layers of a layer stack, firstly desirable, angle-dependent reflectivity and transmission profiles of the layers are defined which are intended to guarantee good imaging properties of the optical system. These desired profiles are referred to as “target” profiles and are generally angle-dependent functions of the complex Fresnel coefficients. The conventional procedure after the definition of these target profiles consists in finding a layer design, that is to say a layer construction, whose associated reflection and transmission profiles approximate the target profiles well. Commercial design programmes can be obtained for this procedure and make it possible, for example in accordance with a “simulated annealing” strategy, to effect a global optimization of a layer system to a desired target profile.

Although the known procedures for layer optimization to given target functions have proved worthwhile in many applications, fundamental problems remain. Firstly, it is often difficult to define suitable target profiles. Even if optimum target profiles for the polarization-dependent reflectances and transmittances or functions of these values are found, it is still not guaranteed that a layer design that can be realized can approximate such a target function sufficiently well. Moreover, different target functions may describe comparably good total systems. Therefore, it often remains unclear which of the target functions present for selection can best be approximated by a layer design that can actually be produced. As a result, the choice of the optimum target functions is made more difficult.

The international patent application WO 02/077692 A1 presents a method for producing optical systems which is intended to make it possible to provide projection objectives with extremely small wavefront aberrations even if the lenses have to a greater or lesser extent inhomogeneities of the refractive index or defects of form. The method comprises a measuring step, in which the refractive index distribution of an optical material used for producing a lens is measured, and a surface measuring step, in which the surface form of a lens is determined. An optical error or a wavefront error of the lens is determined on the basis of the measurement results. On the basis of the calculation results, an optical coating is produced on the lens, said optical coating having a predetermined thickness distribution which is suitable for minimizing the wavefront error. The coating is thus designed for establishing a phase that is as homogeneous as possible at the coated optical component.

### SUMMARY OF THE INVENTION

One object of the invention is to provide a method for making an optical system which makes it possible, in a simple and rapid manner, to optimize the optical system for an envisaged imaging quality with inclusion of the optical effect of interference layer systems on optical components.

Another object of the invention is to provide a catadioptric projection objective comprising a polarization beam splitter, the imaging properties of which are optimized such that the arising of variations of the critical dimensions of imaged structures (CD variations) can be reduced to an amount that is largely noncritical for the practical application.

In view of these objects, the invention proposes, in accordance with one formulation of the invention, a method for making an optical system which is provided for imaging a radiation distribution from an input surface of the optical system into an output surface of the optical system. The optical system has a multiplicity of optical components which determine an imaging quality of the optical system, which are arranged along an optical axis of the optical system and comprise at least one optical component which has a substrate with a substrate surface which is provided for carrying an interference layer system having a layer construction that determines the optical properties of the optical component covered with the interference layer system, the method comprising the following steps of: predefining an optimization target for at least one imaging quality parameter that represents the imaging quality of the optical system; determining the imaging quality of the optical system whilst taking account of the layer construction of the interference layer system; varying the layer construction for the purpose of approximating the imaging quality parameter to the optimization target.

Accordingly, in the case of a method according to the invention, the variation of the layer construction is coupled directly with an assessment of the imaging quality of the total optical system including the interference layer system to be optimized. By virtue of a direct optimization of the layer construction, in particular with regard to number and/or optical layer thicknesses and/or order of the individual layers lying one on top of the other, to the criteria which describe the imaging quality of the optical system, it is possible to avoid the conventional use of target profiles and the problems associated therewith. The optimization can be carried out in an iterative process.

In one embodiment, a (field- and pupil-dependent) total transmission of the optical system is chosen as imaging quality parameter. For this total transmission, certain properties may alternatively or in combination define the optimization target more precisely. In many cases it has proved to be favorable if a minimum variation of the total transmission is chosen as optimization target, that is to say a smoothest possible profile of the total transmission over the angles of incidence occurring within the optical system. If this criterion is met by the total system, then the CD variations described in the introduction, for example, can be reduced to an amount that can be afforded tolerance. As an alternative or in addition it is possible for a maximum total transmission to be chosen as optimization target. If, by way of example, the microlithographic projection objectives are optimized with regard to maximum total transmission, then they enable, per unit time, a high total throughput of exposed substrates and hence an economic fabrication process for semiconductor components and other finely patterned devices. A suitably weighted optimum from a lowest possible variation and a highest possible total transmission may also be chosen as optimization target.

In this application, the term “total transmission” designates the imaging efficiency of the optical system for the radiation passing through. It may be calculated for example from the ratio between the intensity of the radiation that is incident at the input surface into the optical system to the corresponding radiation that emerges at the output surface from the optical system for respectively corresponding angles of incidence. Refraction, reflection and/or diffraction of the radiation may be involved in the imaging of the radiation, depending on the type of optical components.

In preferred variants of the optimization strategy according to the invention, a direct program-technical combination of suitable layer variation algorithms with an assessment of the imaging quality of the entire optical system including the interference layer system to be optimized is provided, which can be carried out rapidly with tenable computational complexity. For this purpose, the step of determining the imaging quality of the optical system comprises determining Jones matrices, which permit in particular a fast and reliable assessment of the total transmission of a system even taking account of the use of polarized radiation. This is explained in more detail below using the example of a system in which the interference layer system to be optimized is a polarization-selective beam splitter layer.

In a ray-based system of co-ordinates, the polarization-optical effect of a layer and also of further polarization elements can be characterized for each individual ray by means of a Jones matrix. Under reflection, the Jones matrix has the following configuration for a layer in the ray-based system of co-ordinates:

$${𝔍}_{refl} = ( \begin{matrix}{e}_{1} \cdot {e}_{s} & {e}_{1} \cdot {e}_{p} \\ {e}_{2} \cdot {e}_{s} & {e}_{2} \cdot {e}_{p}\end{matrix} ) \cdot ( \begin{matrix}{r}_{s} ( θ ) & 0 \\ 0 & {r}_{p} ( θ )\end{matrix} ) \cdot ( \begin{matrix}{e}_{1} \cdot {e}_{s} & {e}_{2} \cdot {e}_{s} \\ {e}_{1} \cdot {e}_{p} & {e}_{2} \cdot {e}_{p}\end{matrix} ) . \qquad ( 1 )$$

In order to distinguish between the reflection and transmission coefficients R_{S}, R_{P}, T_{S}, T_{P} for the intensities, here the complex amplitude coefficients (that is to say: amplitude and phase effect) are identified by lower-case letters rₛ, rₚ, tₛ, tₚ (R_{S}=|rₛ|², R_{P}=|rₚ|², T_{S}=|tₛ|², T_{P}=|tₚ|²). e₁, e₂ and e_{S}, e_{P} are unit vectors in the ray-based and surface-based system of coordinates, respectively, which are defined as follows:

Ray-based:
a=e_{y}−(e_{y} k)ₖ,
e₂=a/|a|
e₁=e₂×k/|e₂×k|
   where e_{y} is the unit vector in the y direction and k is the ray direction vector.
   Surface-based:
s=k×e_{z}
   eₛ=s/|s|
   eₚ=eₛ×k/|eₛ×k|,
      where e_{z} is the unit vector in the z direction.

The Jones matrix under transmission results analogously to this as:

$${𝔍}_{trans} = ( \begin{matrix}{e}_{1} \cdot {e}_{s} & {e}_{1} \cdot {e}_{p} \\ {e}_{2} \cdot {e}_{s} & {e}_{2} \cdot {e}_{p}\end{matrix} ) \cdot ( \begin{matrix}{t}_{s} ( θ ) & 0 \\ 0 & {t}_{p} ( θ )\end{matrix} ) \cdot ( \begin{matrix}{e}_{1} \cdot {e}_{s} & {e}_{2} \cdot {e}_{s} \\ {e}_{1} \cdot {e}_{p} & {e}_{2} \cdot {e}_{p}\end{matrix} ) \qquad ( 2 )$$

All other polarization-optical elements are likewise characterized by Jones matrices, so that the Jones matrix of a total system with a beam splitter and a total of k polarization-optical elements has the following configuration:

$${𝔍}_{total}^{*} = {𝔍}_{k} ⋯ {𝔍}_{n + 2} \cdot {𝔍}_{trans} \cdot {𝔍}_{n} ⋯ {𝔍}_{m + 1} {𝔍}_{refl} {𝔍}_{m - 1} ⋯ {𝔍}_{1}$$

A Jones matrix of the total system is associated with each field and pupil point.

Only the reflection and the transmission Jones matrix is in each case changed by the variation of the beam splitter layer. For this reason, it is possible to combine the matrices before and after the Jones matrices of the beam splitter layer and, instead of the above chain of matrices, the following more compact expression is obtained:

$${𝔍}_{total}^{*} = {𝔍}_{c} \cdot {𝔍}_{trans} \cdot {𝔍}_{b} \cdot {𝔍}_{refl} {𝔍}_{a} . \qquad ( 3 )$$

This represents the Jones matrix of the total system in the ray-based system of co-ordinates.

The matrices ℑa, ℑb, ℑc only have to be calculated once and do not change if a new layer is placed onto the beam splitter surface. ℑa, ℑb, ℑc can be written out for each ray by means of suitable programmes for optical calculations, e.g. by means of the programme CodeV.

For the assessment of the total system, the Jones matrix of the total system,

$${𝔍}_{total}^{*} ,$$

here is preferably additionally multiplied from the left by a ray-dependent rotation matrix. This corresponds to a rotation of the rays arriving at the wafer (that is to say at the output surface) in the direction of the z axis and thus has an influence on the electric fields and hence also on the Jones matrices. This corresponds to a representation of the Jones matrix of a system that is telecentric on the image side in the exit pupil located at infinity.

$${\tilde{𝔍}}_{total} = ( \begin{matrix}cos β & sin β \\ - sin β & cos β\end{matrix} ) \cdot {𝔍}_{total}^{*}$$

Since, in systems comprising a beam splitter, there is often an interest in right-circularly polarized radiation in and out (or in the statistical superposition of left- and right-circular radiation in), the Jones matrix may finally also be represented in a different, namely circular, basis.

$${𝔍}_{total} = ( \begin{matrix}1 & - i \\ 1 & i\end{matrix} ) {𝔍}_{total} ( \begin{matrix}1 & 1 \\ i & - i\end{matrix} ) . \qquad ( 4 )$$

If the entire Jones pupil (for a field point) is first constructed in this basis, the assessment e.g. of the apodisation of the total transmission I can be carried out in a simple manner. A measure of the total transmission (for right-circular radiation in and right-circular radiation out) is produced in this case by means of the square of the magnitude of the 1-1 element of the Jones matrix of the total system in the circular basis:
I=|(ℑₜₒₜₐₗ)_{1,1}|² (5)

In other embodiments, a different measure is also chosen for the total transmission of the total system:
I′=|(ℑₜₒₜₐₗ)_{1,1}|²+|(ℑₜₒₜₐₗ)_{2,1}|² (6)

In contrast to I, I′ describes the intensity of right-circularly radiated in light, independently of whether the state of polarization in the exit pupil is right- or left-circular.

The peak-to-valley value (PV value) of the pupil of I′, which value can be used for characterizing fluctuation ranges, may serve as a measure for assessing the “smoothness” of the total transmission. However, the relative PV value PVᵣₑₗ should always be considered, PVᵣₑₗ=PV/mean value.

Instead of determining the PV value directly from the intensity or total transmission pupil, the latter should also be smoothed beforehand. This takes account of the fact that there is a minimum extent of the orders of diffraction in the exit pupil. Only the variation averaged over this minimum extent is of relevance to the imaging.

Many other quality criteria for the imaging may additionally be determined from the Jones pupil, in accordance with (4). In particular, the variation of the total transmission may be subdivided even more precisely. Symmetrical portions, I_{sym}(nₓ, n_{y})={I(nₓ, n_{y})+I(−nₓ, −n_{y})}/2, and antisymmetrical portions, I_{asym}(nₓ, n_{y})={I(nₓ, n_{y})I(−nₓ, −n_{y})}/2, with respect to the pupil midpoint nₓ=0, n_{y}=0 are responsible for different image errors.

Variations of the (smoothed) symmetrical total transmission I_{sym}^{smooth} are responsible for HV differences and deviations with regard to the pitch linearity, and variations in the antisymmetrical portion provide for telecentric errors. The relative PV values can then be related directly to the symmetrical and antisymmetrical total transmission, respectively:
PV_{rel, sym}={Max(I_{sym}^{smooth})−Min(I_{sys}^{smooth})}/mean value(I^{smooth}) (7)
PV_{rel, sym}={Max(I_{asym}^{smooth})−Min(I_{asys}^{smooth})}/mean value(I^{smooth}) (8)

If these two expressions are used as a measure of the quality of the total transmission, a previously smoothed intensity pupil should once again be taken as a basis.

Another measure of the variation of the symmetrical and antisymmetrical total transmission, respectively, is the relative RMS value. In this case, the following expression is designated as the RMS value: RMS(a)=<(a−<a>)²>^{1/2}. In this case, the pointed brackets < . . . > designate averaging.
RMS_{ref, sym}=RMS(I_{sym})/mean value(I) (9)
RMS_{ref, asym}=RMS(I_{asym})/mean value(I) (10)

In contrast to the PV values (7) and (8), these RMS values should not be evaluated on the previously smoothed intensity or total transmission pupil. Rather, the formation of the RMS value already corresponds to a smoothing which does not overassess individual “outliers”. The advantage of RMS formation is that this can be carried out very much more simply and more rapidly than the “smoothing” (convolution of the intensity pupil with a convolution kernel like a circular disc). A fact which becomes important for an optimization algorithm described in more detail in the exemplary embodiment.

In addition to the assessment of the total transmission which is based only on the 1-1 element of Jones pupil in the circular basis, the deviation of the remaining Jones matrix elements J₁₂, J₂₁, J₂₂ from their ideal configuration can also be incorporated in the evaluation. This means that both phase and amplitude effects are concomitantly assessed indirectly.

The Jones matrix of a “perfect” beam splitter system, which transmits only right-circularly polarized light, but not left-circularly polarized light, has the configuration of a projector matrix in the circular basis:

$${𝔍}_{total}^{perfect} = ( \begin{matrix}\vert a \vert & 0 \\ 0 & 0\end{matrix} ) \qquad ( 11 )$$

An optimization of the beam splitter layer on the basis of Jones pupils can be carried out as follows. The complex reflection and transmission coefficients rₛ, rₚ, tₛ, tₚ of a layer stack which are calculated by means of the “Thin Film Matrix Theory (TFMT)” can be used directly in the Jones formalism, cf. equations (1)-(3). This means that it is also possible to directly determine the entire Jones pupil for one or more field points, e.g. in a circular basis. The intensity pupil can be assessed by means of the relative RMS values (symmetrical and antisymmetrical). Instead of determining, as in conventional optimization algorithms of the type described above, the “distance” between the angle profiles, associated with a layer design, of reflection and transmission coefficients and the target profile, the quality of a layer design can now be determined on the basis of the Jones pupil. One possible form of a “Penalty function” has the following configuration:
E=Σ_{field point}{C₁·RMS_{rel, sym}+C₂·RMS_{rel, asym}+C₃·Max(0,Iₘᵢₙ−mean value(I))+C₄ RMS(|J₁₂ |²)+C₅ RMS(|J₂₁|²)+C₆ RMS(|J₂₂|²)} (12)

The third term in the sum “penalizes” pupils whose average total transmission lies below a previously defined threshold Iₘᵢₙ. C₁C₆ are constants. The terms with the factor C₄, C₅, C₆ additionally assess deviations of the Jones pupil of the total system from its perfect shape, cf. equation (11).

For an optimization algorithm based on a “Penalty” function such as (12), the speed of the assessment plays a crucial part. Typically, per field point, the matrix multiplications described above, depending on raster density, have to be carried out e.g. 2×10³-10⁴ times in order to obtain the total Jones pupil. This is already very complicated. The assessment of the Jones pupil, that is to say the calculation of a penalty function such as in (12), must be able to take place rapidly in comparison with the matrix multiplications in order not to slow down the algorithm even further. This is the case for the penalty function specified in (12), but would not be readily possible with the PV values calculated on a smoothed pupil.

The invention also relates to an optical system comprising an optical axis and at least one physical beam splitter with a polarization-selective beam splitter layer which is tilted by a layer tilting angle about a layer tilting axis relative to the optical axis and can be loaded with radiation from a total angle of incidence range which, in particular, is a function of the layer tilting angle, the orientation of the layer tilting axis and the numerical aperture of the projection objective. The beam splitter layer has reflectance Rₛ^{BS} for s-polarized light and a transmittance Tₚ^{BS} for p-polarized light, in which case profiles of Rₛ^{BS} and Tₚ^{BS} dependent on angle of incidence define a transmission product Rₛ^{BS}·Tₚ^{BS} for corresponding angles of incidence. The beam splitter layer is loaded in a plane parallel to the layer tilting axis in a first angle of incidence range and in a plane perpendicular to the layer tilting axis in a second angle of incidence range, which is larger than the first angle of incidence range. The transmission product is essentially constant for angles of incidence from the first angle of incidence range, while the transmission product for angles of incidence of the second angle of incidence range which lie outside the first angle of incidence range deviates significantly from a mean value of the transmission product of the first angle of incidence range. The deviation is preferably such that the transmission product for angles of incidence outside the first angle of incidence range is substantially lower than that for angles of incidence within the first angle of incidence range. In this way, it is possible to selectively apodize rays from the extreme value ranges of the second, larger angle of incidence range in order, in this way, to obtain a uniform total transmission despite an overall great variation of the transmission product over the total angle of incidence range of the interference layer system for the total system.

The optical system is preferably a catadioptric projection objective for imaging a pattern arranged in an object plane of the projection objective into the image plane of the projection objective, comprising an optical axis and at least one catadioptric objective part, the catadioptric objective part having a concave mirror and a beam deflection device, which has the physical beam splitter with the polarization-selective beam splitter layer.

The above and further features emerge not only from the claims but also from the description and from the drawings, in which case the individual features may be realized, and may represent embodiments which are advantageous and which are protectable per se, in each case on their own or as a plurality in the form of sub-combinations in an embodiment of the invention and in other fields.

### BRIEF DESCRIPTION OF THE FIGURES OF THE DRAWINGS

FIG. 1. shows a schematic illustration of an embodiment of a catadioptric projection objective with a physical beam splitter;

FIG. 2 shows a schematic diagram for elucidating the average transmission of an “ideal”, inclined polarization-selective beam splitter layer;

FIG. 3 shows a schematic diagram for illustrating the angle of incidence distribution for the axial point on an inclined beam splitter layer under reflection as a function of the pupil coordinates;

FIG. 4 shows a schematic flow diagram of an embodiment of a method according to the invention which makes it possible to carry out a global optimization of an interference layer system to the imaging quality of the optical system;

FIG. 5 shows a diagram of the angle of incidence dependence of the reflection and transmission intensity coefficients for a polarization-selective beam splitter layer which has been calculated in accordance with a conventional optimization strategy on the basis of target profiles;

FIG. 6 shows a diagram of the angle of incidence dependence of the reflection and transmission intensity coefficients in the case of an optimization of the total system to minimum variation of the total transmission in accordance with one embodiment of the invention;

FIG. 7 shows a diagram specifying the angle of incidence dependence of the transmission product Rₛ·Rₚ for the conventional optimization in accordance with FIG. 5;

FIG. 8 shows a diagram illustrating the angle of incidence dependence of the transmission product Rₛ·Tₚ in the case of an optimization to low variation of the total transmission in accordance with an embodiment of the invention in accordance with FIG. 6;

FIG. 9 shows a comparative diagram illustrating, for five field points, the average intensities for a conventionally optimized beam splitter layer and for a beam splitter layer optimized in accordance with one embodiment of the invention; and

FIG. 10 shows a comparative diagram specifying, for five field points, relative peak-to-valley values (PV values) of the transmission pupils for a conventionally optimized beam splitter layer and for a beam splitter layer optimized in accordance with one embodiment of the invention.

### DETAILED DESCRIPTION OF PREFERRED EMBODIMENTS

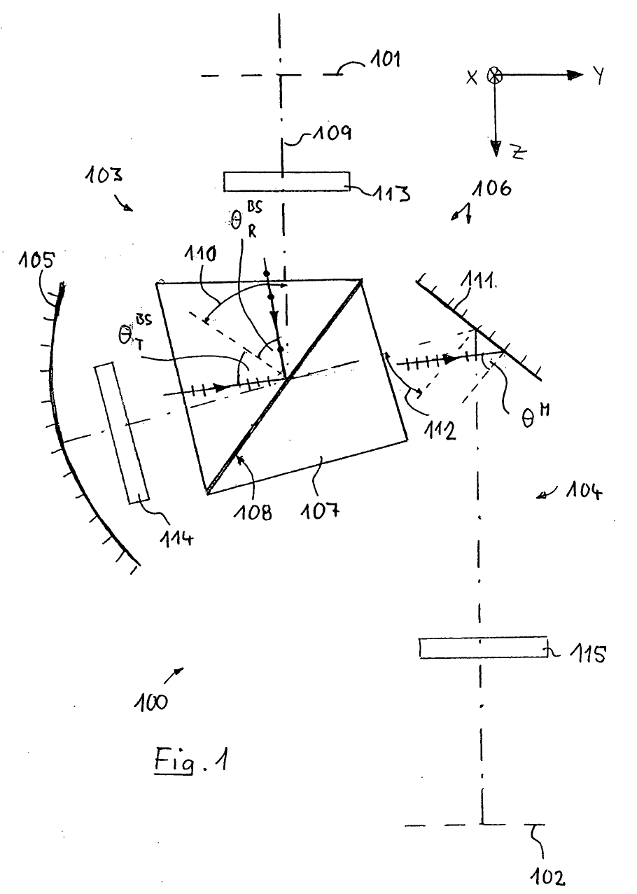

FIG. 1 schematically shows the construction of an embodiment of a catadioptric reduction objective 100 according to the invention. It serves, at an operating wavelength in the deep ultraviolet range of approximately 157 nm, for imaging a pattern of a reticle or the like arranged in the object plane 101 into the image plane 102 on a reduced scale, for example with the ratio 4:1, with exactly one real intermediate image being generated. The projection objective has, between the object plane and the image plane, a catadioptric objective part 103 and behind that a purely dioptric objective part 104. The lens of the objective parts which serve for imaging are not illustrated for reasons of clarity.

The catadioptric objective part 103 comprises a concave mirror 105 and a beam deflection device 106. The beam deflection device comprises a physical beam splitter 107 with a polarization-selective beam splitter layer 108, which is formed by a multilayer interference layer system made of dielectric materials having different refractive indices and is arranged between planar surfaces of two transparent prisms. The beam splitter layer 108 is tilted by a layer tilting angle 110 of approximately 52° relative to that part of the optical axis 109 which is perpendicular to the object plane 101. Other layer tilting angles, e.g. 45°, are also possible. The layer tilting axis which is perpendicular to the plane of the drawing runs parallel to the x axis of the total system. The beam deflection device 106 furthermore comprises a deflection mirror 111 arranged in the light path directly behind the beam splitter 107, the planar mirror surface of which deflection mirror is oriented perpendicular to the plane of the beam splitter layer 108 and is accordingly tilted at a mirror tilting angle 112 of approximately 38° relative to the associated part of the optical axis. In conjunction with the reflection at the beam splitter layer 108, the planar deflection mirror 111 enables a parallel arrangement of object plane and image plane, thereby facilitating a scanner operation of mask and wafer. The deflection mirror 111 is not mandatory optically; there are also embodiments without such deflection mirrors or variants with more than one deflection mirror.

The projection objective 100 is designed for operation with circularly polarized light and has, between object plane 101 and beam splitter 107, a device—designed for example as a λ/4 plate 113—for converting circularly polarized light into light which is s-polarized with regard to the beam splitter layer 108. Arranged between the beam splitter layer 108 and the concave mirror 105 is a polarization rotating device 114, which has the effect of a λ/4 plate and accordingly brings about a rotation of the preferred direction of polarization by 90° in the case of double passage of light. In the refractive objective part 104, there is provided between the deflective mirror 111 and the image plane 102 a delay device 115 with the effect of a λ/4 plate, which converts the entering linearly polarized light into circularly polarized light as an equivalent to unpolarized light.

The light which comes from the object plane 101 and is incident in the beam splitter 107 is s-polarized with regard to the beam splitter layer 108 after passing through the λ/4 plate 113 and is reflected by said beam splitter layer at a deflection angle of approximately 104° in the direction of the concave mirror 105. The reflectance Rₛ^{BS} dependent on the associated angle θ_{R}^{BS} of incidence is a determining factor for the efficiency of this reflection. In the case of the embodiment, a total angle of incidence range of approximately θ_{R}^{BS}=52°±8° occurs in the case of this reflection. After passing through the device 114, the reflective light passes in circularly polarized fashion onto the concave mirror, is reflected by the latter and, after once again passing through device 114, is p-polarized with regard to the beam splitter layer, so that this is transmitted or allowed to pass by the latter. The transmittance T_{P}^{BS} dependent of the associated angle θₜ^{BS} of incidence is a determining factor for this transmission. The optical components in particular between beam splitter and concave mirror are designed such that there is an unambiguous angular relationship between the angles of incidence associated with reflection and with transmission, respectively, over the entire angle of incidence range, to a first approximation θ_{R}^{BS}=θ_{T}^{BS} holding true. For the subsequent reflection at the deflection mirror 111, the latter's reflectance R^{M}ₚ dependent on the associated angle θ^{M} of incidence is a determining factor for p-polarized light. It is evident that the total transmission of the beam deflection device 106, that is to say the latter's forwarding efficiency for light, depends in the case of the embodiment shown on Rₛ^{BS}, Tₚ^{BS} and Rₚ^{M}, which are in turn functions of the respective angles of incidence.

The intensity of the light which is radiated in right-circularly and finally passes through the projection objective is referred to as “total transmission”. The intensity of the components which are radiated in left-circularly and passed through the system is referred to as “stray transmission or “orthogonal component”.

Even a fictitious, “ideal” beam splitter layer whose reflection and transmission coefficients yielded the (not realistic) values Rₛ^{id}=1, Rₚ^{id}=0, Tₛ^{id}=0 and Tₚ^{id}=1 over the entire angle of incidence range would lead to apodizations of the total transmission in the exit pupil. This is due, inter alia, to the fact that the decomposition into s component and p component depends on the respective ray direction at the beam splitter surface. Since the amplitude portions of the s and p components thus vary with the ray direction, even such an “ideal” beam splitter layer gives rise to apodizations. This purely geometrical effect becomes even significantly more complicated by virtue of the coupling with other polarization elements (λ/4 plates, highly reflective mirror layers (HR layers), antireflection layers (AR layers), intrinsic birefringence (IB), stress birefringence (SB)).

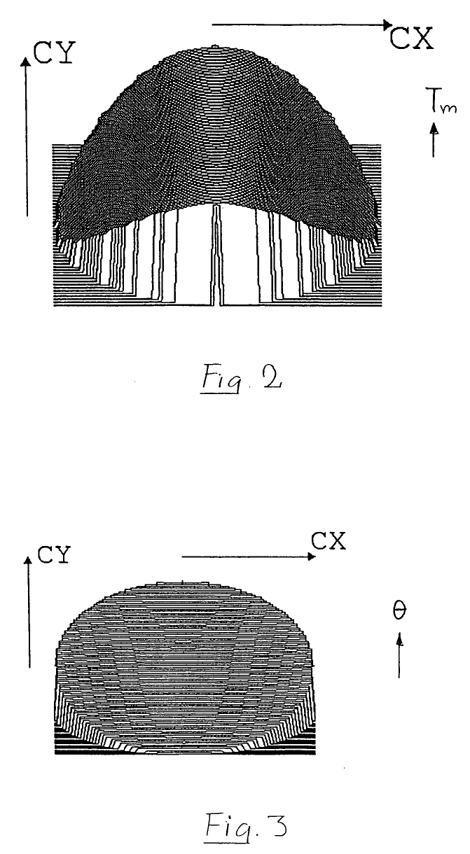

For an axial point, this “geometry effect” brings about apodization of those radiation bundles which are spread out along the x axis, that is to say parallel to the layer tilting axis. In contrast thereto, the ray bundle spread out along the y axis is not apodized. In FIG. 2, these conditions are illustrated schematically by means of a uniaxially curved transmission pupil. In this case, the diagram shows the average transmission Tₘ as a function of the pupil coordinates in the x and y directions. A very similar shape of the “transmission pupil” results for a field edge point.

For the radiation passing through, the inclination of the beam splitter layer means the following: the radiation bundle spread out along the y axis sees a larger angle of incidence range on the beam splitter surface than the radiation bundle of the x section. This is due to the inclination of the beam splitter surface relative to the optical axis, in the case of which the beam splitter layer is tilted about a layer tilting axis when in parallel to the x axis. In FIG. 1, the x axis of the figure points into the plane of the drawing, while the y axis points toward the right. For the y radiation bundle (in the plane of the drawing), the smallest angles of incidence are obtained for rays running upward (cy=+|cy|) and the largest angles of incidence arise for those rays which run downward (cy=−|cy|). The situation is different for the x radiation bundle: the rays with positive direction cosines (cx=+|cx|) see the same angles of incidence of the beam splitter surface as those rays with negative direction cosines (cx=−|cx|).

Overall, the angle of incidence range of the “x radiation bundle”, which is also referred to here as the first angle of incidence range, is smaller than that of the y radiation bundle, which is also referred to here as the second angle of incidence range. In this case, in the angle of incidence range of the y bundles (θ≈52°±8°) compared with that of the x bundles (θ≈52°±6°), in addition to the angles of incidence present there, even larger and smaller angles of incidence occur in the edge regions of the total angle of incidence distribution. These conditions are shown schematically in FIG. 3. The diagram therein shows the distribution of the angle of incidence values θ for the axial point on the beam splitter surface under reflection as a function of the pupil coordinates. It is evident from the inclination of the surface shown that a broader spectrum of angles of incidence results in the y direction.

The shape of the transmission pupil as shown in FIG. 2 greatly affects the CD variations mentioned in the introduction, which are often also referred to as horizontal-vertical differences (HV differences). Orders of diffraction which are positioned along the x principal section acquire a very much smaller average intensity than those which are distributed along the y principal section. This applies in particular to the range of large numerical apertures, for example with values of NA≧0.8 or ≧0.9. For the layer design, then, the task is to take account of this disadvantageous property of the total optical system and, if possible, to at least partly compensate for it.

A preferred embodiment of an optimization method according to the invention is specified below, which method uses a direct coupling of the layer variation with the assessment of the total system (including the beam splitter layer to be optimized) for the purpose of determining a suitable layer design for the beam splitter layer. In this case, the calculation is carried out with the aid of the Jones matrices explained in the introduction.

A preprocessing phase comprises the following steps:

1. Select a number of field points representing the entire object field. The number of field points results from a compromise: accuracy <−> speed.

2. Calculate and store for each of the field points under 1. and for each associated pupil point the submatrices ℑₐ, ℑ_{b}, ℑ_{c}, cf. (3), and also the rotation and basis change matrices in (3)-(4).

3. Calculate and store for each ray (field- and pupil-dependent) the basis change matrices necessary for calculating (1) and (2). The ray direction vectors necessary for this are produced by a “Ray Tracing”.

4. Select a beam splitter layer as “start layer” (characterized by complex refractive indices, number and thicknesses of the individual layers of a layer stack).

5. Define the constants C₁-C₆ for the penalty function (12).

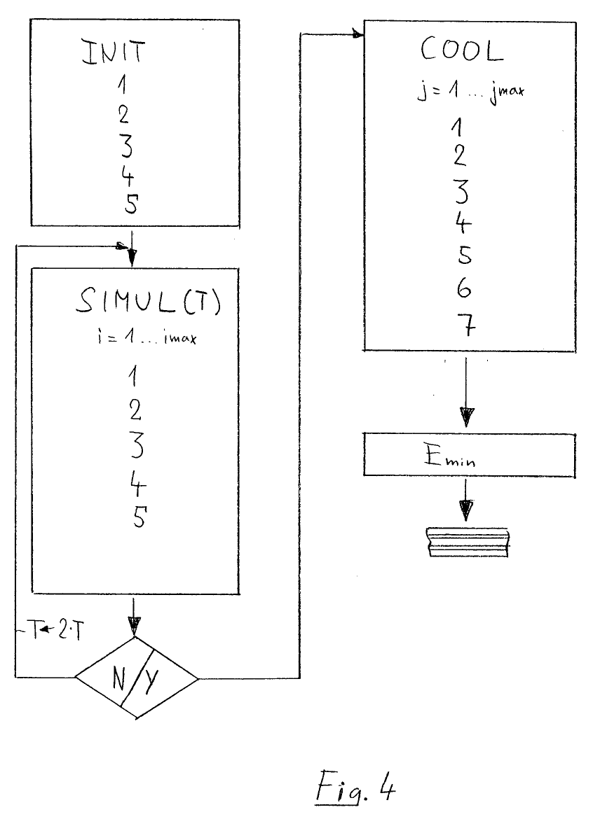

The optimization of the layer construction of the beam splitter layer is then carried out by means of a “Simulated Annealing” algorithm, which is explained in more detail with reference to FIG. 4.

The following steps are carried out in an initialization phase (INIT):

1. Set the value for the temperature T to a value Tₛ for a start temperature

2. Calculate the profiles of rₛ(θ), rₚ(θ), tₛ(θ), tₚ(θ) associated with the start layer

3. Calculate using the coefficients rₛ(θ), rₚ(θ), tₛ(θ), tₚ(θ) for each field point the Jones pupils, that is to say for each field and pupil point the total Jones matrix ℑₜₒₜₐₗ, (4), in the manner described above

4. Calculate the penalty function E₀ for this start layer

5. Calculate the current layer therefrom.

In a subsequent simulation phase at temperature T (SIMUL(T)), the following steps are subsequently carried out repeatedly in a suitable number i of steps:

1. Vary the current layer

2. Calculate the associated complex coefficients rₛ(θ), rₚ(θ), tₛ(θ), tₚ(θ) by means of TMFT

3. Calculate using the coefficients rₛ(θ), rₚ(θ), tₛ(θ), tₚ(θ) for each field point the Jones pupils, that is to say for each field and pupil point the total Jones matrix ℑₜₒₜₐₗ, (4), in the manner described above

4. Calculate the penalty function E, (12).

5. Accept the varied layer as new (current) layer if E-E₀<0. If E−E₀>0, accept the varied layer only with the probability exp(−(E−E₀)/T).

6. In the case of acceptance: E₀←E

In a decision phase (N/Y), a decision is then made as to whether the percentage of accepted, new layers lies above a previously defined threshold value, which may be 80%, by way of example. If this is not the case, then a temperature doubling step (T←2·T) is carried out and the simulation is repeated for this temperature.

If a sufficiently high percentage of accepted new layers is found in this way for a sufficiently high temperature, then the optimization undergoes transition to the subsequent cooling phase (COOL), which corresponds to a simulation at a slowly cooling temperature T. In this case, a cooling factor 0<χ<1 is chosen, which is generally near to the value 1, for example χ=0.99. A subsequent iteration stage for the running variable j then comprises the following steps:

1. T←T*χ

2. Vary the current layer

3. Calculate the associated complex coefficients rₛ(θ), rₚ(θ), tₛ(θ), tₚ(θ) by means of TMFT

4. Calculate using the coefficients rₛ(θ), rₚ(θ), tₛ(θ), tₚ(θ) for each field point the Jones pupils, that is to say for each field and pupil point the total Jones matrix ℑₜₒₜₐₗ, (4), in the manner described above

5. Calculate the penalty function E, (12).

6. Accept the varied layer as new (current) layer if E−E₀<0. If E−E₀>0, accept the varied layer only with the probability exp(−(E−E₀)/T).

7. In the case of acceptance: E₀←E

Finally, in a selection step (Eₘᵢₙ) that layer having the smallest penalty function E is picked out from all the layers generated in the course of the simulation. This layer construction represents the beam splitter layer construction which is optimized according to this algorithm and produces a minimum variation of the total transmission for the total system.

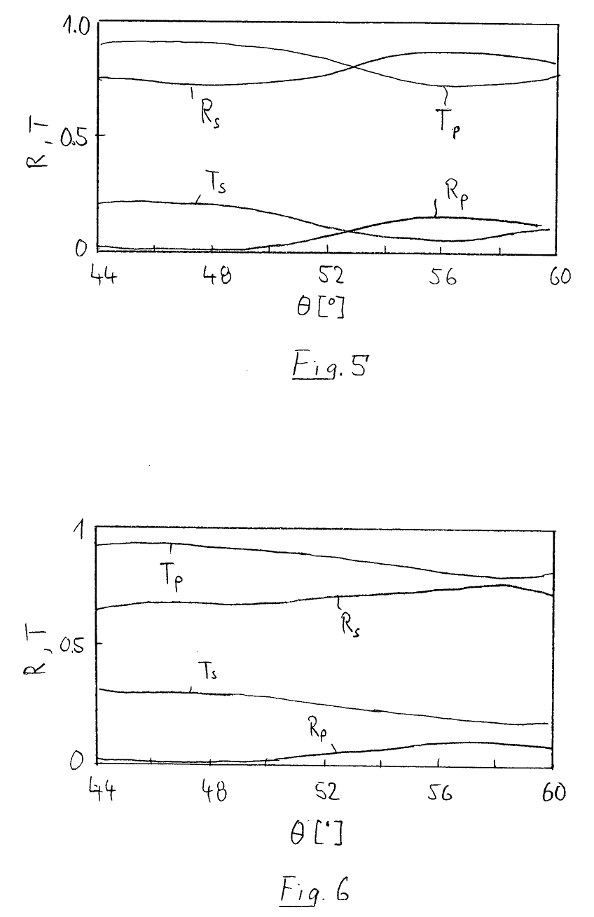

In the text below, with reference to FIGS. 5 to 10, the result of the simulation process is explained and compared with the result of a conventional layer optimization on the basis of target profiles.

The transmission product Rₛ·Tₚ was chosen as the quantity whose target profile was defined for the beam splitter design in the case of conventional optimizations. Since the angles of incidence under reflection and under transmission at the beam splitter layer are identical to a good approximation, a constant Rₛ·Tₚ over the entire angular range appears to promise an essentially constant intensity in the exit pupil of the total system. Moreover, during the layer optimization, additional targets that are intended to be achieved are a minimum Rₚ and also a minimum Tₛ over the entire angular range, in order thus to suppress the undesirable components. The targets of the conventional layer optimization are thus defined.

The following hold true for the conventional layer optimization: the purely geometrical apodization effects discussed above, in addition deviations from the constancy sought for Rₛ·Tₚ, and also—despite minimum values for Rₚ and Tₛ—light which passes through the objective and was p-polarized under reflection at the beam splitter surface and/or s-polarized upon transmission, will contribute to the field- and pupil-dependent variation of the transmission.

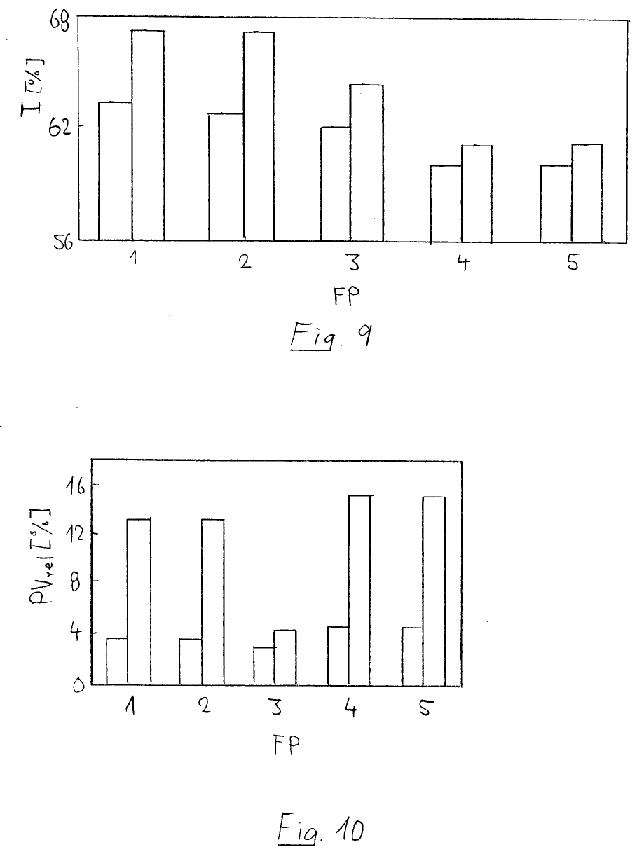

The relative intensity I of the average transmission (FIG. 9) and also the relative PV value PVᵣₑₗ of the smoothed transmission pupils for various field points (FIG. 10) are considered here as comparison criteria for the two layer designs.

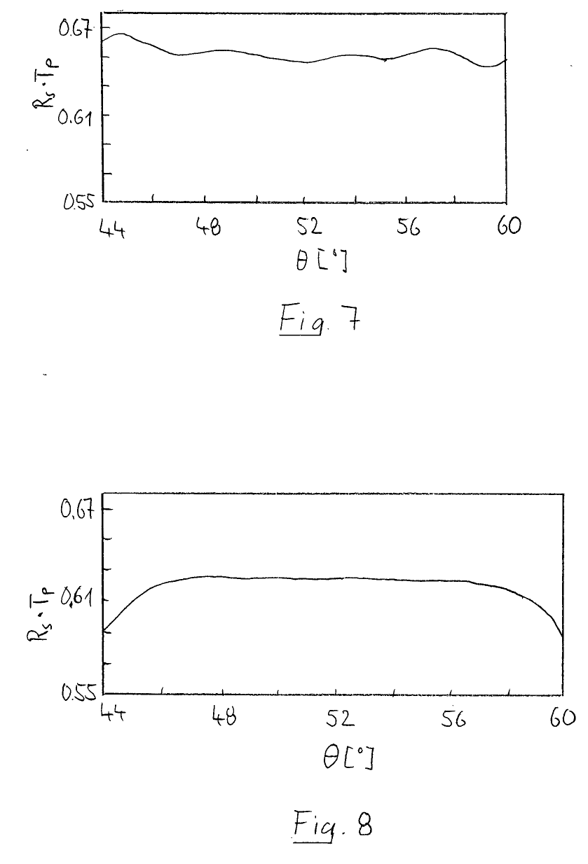

Firstly, the reflection and transmission coefficients of the two layers produced are compared. The consideration of the profile of Rₛ·Tₚ (FIGS. 7 and 8) is of interest when comparing the two optimization strategies. The conventional optimization strategy involves attempting to keep said profile as constant as possible over the entire angular range (FIG. 7). While the conventional optimization strategy exhibits a rather irregular variation of the product Rₛ·Tₚ that is moderate over the total range (fluctuation range approximately 2 percentage points), the result of the newly proposed optimization method comprises a regular, systematic deviation from the constancy of Rₛ·Tₚ at the edges of the relevant total angular range (total fluctuation range>2 percent), while there is a very small fluctuation range (<0.5 percent) in the central region (FIG. 8). FIG. 7 also shows that it is evidently difficult to approximate the desired target (constancy of Rₛ·Tₚ) well over the entire angle of incidence range.

A layer design of a beam splitter layer designed for 157 nm is shown by way of example in the table below. In the case of the alternate layer system, lanthanum fluoride (LaF₃) where n=1.75111 is used as dielectric material having a high refractive index and magnesium fluoride (MgF₂) where n=1.48 is used as dielectrical material having a low refractive index. The first layer nearest the substrate consists of MgF₂. On the light entrance side, an outer layer made of silicon dioxide (n=1.67) is also applied to the MgF₂—LaF₃ alternate layer system. The table shows the geometrical layer thickness of the individual layers in [nm].

| Layer No. | Thickness [nm] | Material |
|---|---|---|
| 1 | 28.5 | MgF₂ |
| 2 | 12.9 | LaF₃ |
| 3 | 46.4 | MgF₂ |
| 4 | 10.0 | LaF₃ |
| 5 | 44.7 | MgF₂ |
| 6 | 22.0 | LaF₃ |
| 7 | 47.2 | MgF₂ |
| 8 | 29.7 | LaF₃ |
| 9 | 44.9 | MgF₂ |
| 10 | 30.5 | LaF₃ |
| 11 | 46.4 | MgF₂ |
| 12 | 27.6 | LaF₃ |
| 13 | 10.0 | SiO₂ |

The bar charts of FIGS. 9 and 10 provide information about which of the two layer designs to be compared is better in the sense of constancy of the total transmission over field and pupil coordinates. The transmission or intensity pupils for five different field points (FP) are shown. They are four edge points of the field and the axial point. The field coordinates are specified at the reticle (that is to say for the object plane). The left-hand bars in each case show the values of the simulation according to the invention, while the right-hand bars represent the result of the conventional method.

Although the average transmission of the beam splitter layer obtained with the new method is somewhat lower in the case of the example than in the case of the conventionally optimized layer, in return the field-dependent variation is significantly smaller (FIG. 9).

The newly proposed optimization method produces a significantly weaker variation of the intensity as a function of field and pupil coordinates. That becomes clear if the relative PV values (peak-to-valley values) of the intensities are compared (FIG. 10).

A large number of experiments have shown that all beam splitter layers which in principal follow the profile of the transmission product shown by way of example in FIG. 8 over the total angle of incidence range yield significantly lower values for the HV differences in comparison with conventionally optimized beam splitter layers. This profile is characterized in that a largely constant profile of the transmission product is present in a first angle of incidence range, which corresponds to the angles of incidence that occur in the x section in the case of the example. “Largely constant” means, in particular, that the fluctuation range in the range considered amounts to less than 1 percent, in particular less than 0.5 percent, of Rₛ·Tₚ. In FIG. 8, said first angle of incidence range extends approximately between 46° and 58° angle of incidence, that is to say in a range of approximately ±6° around that angle of incidence which axially parallel rays have (52°). In the perpendicular section thereto along the y axis, angles of incidence occur which are both larger and smaller in terms of absolute value, thus resulting in a second angle of incidence range encompassing all angles of incidence occurring in the y section. The second angle of incidence range (52°±8°) thus encompasses angle of incidence values which lie outside the first angle of incidence range and represent the extreme values of the total angle of incidence distribution. In these edge regions lying outside the first angle of incidence range, the transmission product is significantly lower than the mean value within the first angle of incidence range, a clearly discernible edge fall-off being established. Typical fluctuation ranges in the edge regions may be in particular more than 1 or more than 2 or more than 3 percent of Rₛ·Tₚ. The layer system thus has, for extremely large and extremely small angles of incidence, a transmission which is significantly reduced compared with more moderate angles of incidence and which brings about an apodization of the extreme marginal rays.

By means of a beam splitter layer which has at least approximately such a profile of the transmission function over the total angle of incidence range, it is possible to apodize the marginal or coma rays of the y radiation bundle in the range of large angles, while the marginal or coma rays of the x radiation bundle are practically not apodized. HV differences can be reduced in this way. The transmission product Rₛ·Tₚ of a “good layer” should therefore decrease at particularly large and particularly small angles of incidence in order, in this way, to apodize the marginal or coma rays of the y radiation bundle.

For the application in a microlithographic projection objective with a polarization-selective beam splitter, in accordance with the inventors' insights it should be endeavored to achieve in the exit pupil an intensity distribution which deviates as little as possible from a rotationally symmetrical distribution. This target is counteracted by the “geometry effect” mentioned in the introduction, which, without further measures, leads to a “double ripple” in the intensity distribution in the exit pupil, the intensity being largely constant in the y direction, whereas it has a curvature with edge fall-off in the x direction running perpendicular thereto. By means of a beam splitter layer designed in complementary fashion, the transmission product of which is largely constant in the x direction, while a curvature with edge fall-off is produced in the y direction (cf. FIG. 8), the geometry effect can at least partly be compensated for, so that a rotational symmetry of the intensity in the exit pupil can at least approximately be achieved. In this way, it is possible to provide lithographic systems which contain a polarizing beam splitter layer in at least one passage, and which are characterized in that the proportion of the non-rotationally symmetrical maximum variation of the intensity in the exit pupil of a field point (peak-to-valley value) does not exceed 40% of the total variation of the intensity of the exit pupil at this field point. Preferably, the value of 20% of the total variation of the intensity in the exit pupil is not exceeded.

Since the “geometry effect” results in a pronounced double ripple in the intensity distribution in the exit pupil, it can also be discerned from the amplitudes of the Zernike coefficients Z5 and Z6, which characterize a double ripple in a function relative to two directions rotated by 45° with respect to one another. Preferred variants of lithographic systems according to the invention which contain a polarizing beam splitter layer in at least one passage are characterized in that the amplitudes of the Zernike coefficients Z5 and Z6 in an expansion of the intensity profile in the exit pupil according to Zernike coefficients at a field point do not exceed 20% of the total variation. It may preferably be achieved that a value of 10% of the total variation of the intensity in the exit pupil is not exceeded.

The abovementioned quality features are typical of catadioptric projection objectives with a polarization-selective beam splitter, the beam splitter layer of which has the double ripple in its properties (cf. FIG. 8). Such beam splitter layers may be characterized in particular in that the relative peak-to-valley variation
PV=2·(Max[I(α)]−Min[I(α)])/(Max[I(α)]+Min[I(α)])
of the intensity of the useful light transmitted overall, over the range of all the angles of incidence that occur at the beam splitter layer, deviates by less than 50%, in particular by less than 30%, from the quantity
Δ|φ=cos²(2φ)
where φ is half the aperture angle of the bundle of rays at a field point on the beam splitter layer. It is thus endeavored to set the optical effect of the beam splitter layer such that the variation of the transmission product in the y direction is adapted to the “swing” of the transmission in the x direction that is brought about by the geometry effect (that is to say is adapted to the curvature of the transmission profile in the x direction). Said curvature can be approximated in the case of the double passage essentially by means of the cos² function specified above.

The basic profile of the transmission product of preferred beam splitter layers has a characteristic “edge fall-off” of the transmission product for a direction that is perpendicular to the direction in which the geometry effect provides for an edge fall-off of the transmission of the system. In this case, it has proved to be particularly favorable if said edge fall-off is present in both extreme regions of the angle of incidence spectrum approximately in a similar manner (cf. FIG. 8). On the other hand, the edge fall-off ought not to be so great that rays associated with large angles of incidence are apodized to an excessively greater extent. Consequently, a largely symmetrical edge fall-off is favorable, in the case of which, however, the deviations from the region of best transmission do not become too large. Preferred embodiments are distinguished by the fact that the center-edge variation
I(α_{center})−I(αₘₐₓ) and, respectively I(α_{center})−I(αₘᵢₙ)
deviate from one another by less than 50%, a deviation of less than 30% being particularly favorable. In this case, I(α) denotes the useful light transmitted overall by the beam splitter layer for a specific angle of incidence, and the parameters αₘᵢₙ, α_{center} and αₘₐₓ denote the minimum, medium and maximum angle of incidence occurring. When these conditions are met, the compensation of the geometry effect can be achieved without the total transmission of the optical system being impaired more than is necessary for the compensation.

The invention has been explained using the example of optimizing a polarization-selective beam splitter layer. However, the area of application of the invention is in no way restricted to determining beam splitter layers or to making optical systems with polarization-selective beam splitters. In the manner according to the invention it is also possible to optimize layer designs for antireflection layers (AR layers) or highly reflective interference layer systems (HR layers) whilst taking account of the optical properties of the total system.

The above description of the preferred embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

1. A method for making an optical system for imaging a radiation distribution from an input surface of the optical system into an output surface of the optical system, the optical system comprising a plurality of optical components which determine an imaging quality of the optical system, which are arranged along an optical axis of the optical system and comprise at least one optical component which has a substrate with a substrate surface for carrying an interference layer system having a layer construction that determines the optical properties of the optical component covered with the interference layer system, comprising:
predefining an optimization target for at least one imaging quality parameter that represents the imaging quality of the optical system;
determining the imaging quality of the optical system while taking account of the layer construction of the interference layer system; and
varying the layer construction for approximating the imaging quality parameter to the optimization target.

2. The method as claimed in claim 1, wherein a total transmission of the optical system is chosen as the at least one imaging quality parameter.

3. The method as claimed in claim 2, wherein a minimum variation of the total transmission is chosen as the optimization target.

4. The method as claimed in claim 2, wherein a maximum total transmission is chosen as the optimization target.

5. The method as claimed in claim 2, wherein a weighted optimum from a lowest possible variation and a highest possible total transmission is chosen as the optimization target.

6. The method as claimed in claim 1, wherein said determining the imaging quality of the optical system comprises determining Jones matrices.

7. The method as claimed in claim 2, wherein a peak-to-valley variation parameter is determined for the purpose of determining a variation of the total transmission and a smoothing step is carried out for the variation parameter.

8. The method as claimed in claim 2, wherein a parameter for the portions that are symmetrical with respect to a pupil midpoint is determined for determining a variation of the total transmission.

9. The method as claimed in claim 2, wherein a parameter for the portions that are antisymmetrical with respect to a pupil midpoint is determined for determining a variation of the total transmission.

10. The method as claimed in claim 2, wherein a relative RMS value for a pupil-dependent transmission loss is determined for determining a variation of the total transmission.

11. The method as claimed in claim 1, wherein a distance function between a current value for the imaging quality parameter and the optimization target is determined in association with varying the layer construction.

12. The method as claimed in claim 1, wherein deviations of a Jones pupil of the optical system from an ideal shape of the Jones pupil are determined in association with determining the distance function.

13. The method as claimed in claim 1, wherein the layer construction of a polarization-selective interference layer system which is inclined by a layer tilting angle relative to the optical axis is determined.

14. An optical system comprising:
an optical axis; and
at least one physical beam splitter with a polarization-selective beam splitter layer which is tilted by a layer tilting angle about a layer tilting axis relative to the optical axis; wherein
the beam splitter layer is loaded in a first plane parallel to the layer tilting axis in a first angle of incidence range and in a second plane perpendicular to the layer tilting axis in a second angle of incidence range, which is larger than the first angle of incidence range;
the beam splitter layer has a reflectance Rₛ^{BS} for s-polarized light and a transmittance Tₚ^{BS} for p-polarized light, and in which case profiles of Rₛ^{BS} and Tₚ^{BS} dependent on angle of incidence define a transmission product Rₛ^{BS}·Tₚ^{BS} for corresponding angles of incidence; and
the transmission product for angles of incidence from the first angle of incidence range is essentially constant, while the transmission product for angles of incidence of the second angle of incidence range which lie outside the first angle of incidence range deviates significantly from a mean value of the transmission product of the first angle of incidence range.

15. The optical system as claimed in claim 14, wherein the transmission product for angles of incidence outside the first angle of incidence range is substantially lower than that for angles of incidence within the first angle of incidence range.

16. The optical system as claimed in claim 14, wherein a fluctuation range within the first angle of incidence range is less than 1 percent of the transmission product Rs·Tp.

17. The optical system as claimed in claim 14, wherein a fluctuation range in regions of the second angle of incidence range which lie outside the first angle of incidence range is more than 1 percent of the transmission product Rs·Tp.

18. The optical system as claimed in claim 14, which is a catadioptric projection objective for imaging a pattern arranged in an object plane of the projection objective into the image plane of the projection objective, comprising:
at least one catadioptric objective part;
the catadioptric objective part having a concave mirror and a beam deflection device, which comprises the physical beam splitter with the polarization-selective beam splitter layer that is tilted by a layer tilting angle about a layer tilting axis relative to the optical axis.

19. A lithography-optical system containing a polarizing beam splitter layer in at least one passage, wherein a proportion of the non-rotationally symmetrical maximum variation of the intensity in the exit pupil of a field point does not exceed 40% of the total variation of the intensity in the exit pupil at this field point.

20. The lithography-optical system as claimed in claim 19, wherein the proportion of the non-rotationally symmetrical maximum variation of the intensity in the exit pupil of a field point does not exceed 20% of the total variation of the intensity in the exit pupil at this field point.

21. A lithography-optical system containing a polarizing beam splitter layer in at least one passage, wherein amplitudes of the Zernike coefficients Z5 and Z6 in an expansion of the intensity profile in the exit pupil according to Zernike coefficients at a field point do not exceed 20% of the total variation of the intensity in the exit pupil at this field point.

22. The lithography-optical system as claimed in claim 21, wherein the amplitudes of the Zernike coefficients Z5 and Z6 in an expansion of the intensity profile in the exit pupil according to Zernike coefficients at a field point do not exceed 10% of the total variation of the intensity in the exit pupil at this field point.

23. A beam splitter layer in a lithographic system, in which a relative peak-to-valley variation
PV=2·(Max[I(α)]−Min[I(α)])/(Max[I(α)]+Min[I(α)])
of the intensity of the useful light transmitted overall, over the range of all the angles of incidence that occur at the beam splitter layer, deviates by less than 50% from the quantity
Δ|φ=cos²(2φ)
where φ is half the aperture angle of the bundle of rays at a field point on the beam splitter layer.

24. The beam splitter layer as claimed in claim 23, in which the relative peak-to-valley variation PV deviates by less than 30% from the quantity Δ|(φ).

25. A beam splitter layer in a lithographic system, in which center-edge variations
I(α_{center})−I(αₘₐₓ) and, respectively I(α_{center})−I(αₘᵢₙ)
deviate from one another by less than 50%, where I(α) is the intensity of the useful light transmitted overall by the beam splitter layer for a specific angle of incidence, and αₘᵢₙ, α_{center} and αₘₐₓ denote, respectively, the minimum angle, the medium angle and the maximum angle of incidence occurring.
